(19) United States
(12) Patent Application Publication
(10) Pub. No.: US 2009/0042176 A1
(43) Pub. Date: Feb. 12, 2009

(54) ON-LINE EDUCATION METHOD

(75) Inventor: Mun Sik Nam, Daegu (KR)

Correspondence Address: KNOBBE MARTENS OLSON & BEAR LLP, 2040 MAIN STREET, FOURTEENTH FLOOR, IRVINE, CA, 92614, US

(73) Assignee: HAPPYEDU CO., LTD., Daegu (KR)

(21) Appl. No.: 12/258,051

(22) Filed: Oct. 24, 2008

Related U.S. Application Data
(63) Continuation of application No. PCT/KR2008/000572, filed on Jan. 30, 2008.

(30) Foreign Application Priority Data
Apr. 23, 2007 (KR) 10-2007-0039535

(51) Int. Cl. G09B 7/00

(52) U.S. Cl. 434/323; 434/327; 434/362

(57) ABSTRACT

Disclosed is an on-line education method using an Internet. The on-line education method includes (a) a basic learning step for providing a learner with a concept lecture video for a predetermined learning category, (b) a feedback learning step for providing a predetermined number of questions to the learner together with at least one of correct solutions, explanations, solution videos and concept videos to allow the learner to review a content of the concept lecture video provided in step (a), (c) an instant test step for providing questions selected by the learner according to a degree of difficulty and a number of questions together with a correct solution, explanation, a solution video and a concept video for each question, and an instant test feedback sham examination step for providing questions, which are similar to the questions that the learner fails to answer in step (c).

### CROSS-REFERENCE TO RELATED PATENT APPLICATIONS

This application is a continuation application under 35 U.S.C. § 365(c) of International Application No. PCT/KR2008/000572, filed Jan. 30, 2008 designating the United States. This application further claims the benefit of the earlier filing date under 35 U.S.C. § 365(b) of Korean Patent Application No. 10-2007-0039535 filed Apr. 23, 2007. This application incorporates herein by reference International Application No. PCT/KR2008/000572 and Korean Patent Application No. 10-2007-0039535 in their entirety.

### BACKGROUND

1. Field

The present disclosure relates to an on-line education method.

2. Discussion of the Related Technology

In general, the conventional education was prosecuted through an off-line scheme, in which professors or teachers give a lecture to students according to a predetermined curriculum in a specific place, such as a school or an academic institute.

However, such a conventional off-line education scheme causes additional time and cost because the students may need to move to the studying place. Further, the conventional off-line lecture was prosecuted based on the standard level of the students regardless of various characteristics of the students.

Recently, an on-line education scheme has been proposed to allow the students to study at home through an Internet without moving to the studying place. According to the on-line education scheme, the students download lectures that have been previously prepared or attend the lectures in real time. In addition, questions are randomly provided from an item pool (a question bank), in which many item analysis cards are systemically classified, and the students solve the questions and submit the answer for the questions in such a manner that the learning achievement of the students can be evaluated.

### SUMMARY

One aspect of the invention provides an on-line education method, which comprises: sending educational contents to a remote terminal of a student; providing the student with a plurality of degrees of difficulty of test questions for selection; receiving, from the student, a selection of one of the plurality of degrees of difficulty; sending, to the student, test questions on the educational contents, wherein the test questions are of the selected degree of difficulty; and providing, to the student, at least one selected from the group consisting of correct answers to at least part of the test questions, solutions for solving problems in at least part of the test questions, and at least part of the educational contents relevant to solving at least part of the test questions.

The foregoing method further comprises: prior to sending the test questions, selecting the test questions from a bank of questions in accordance with the selection. The method further comprises: providing the student with a choice of selecting a number of test questions; and receiving, from the student, a selected number of test questions, wherein the selected number of test questions are sent to the student. The method further comprises: receiving, from the student, the student's answers to the test questions; identifying at least one test question to which the student had an incorrect answer; and sending, to the student, one or more additional questions relating to a concept included in the educational contents to which the at least one test question relates. The method further comprises: providing, to the student, at least one selected from the group consisting of correct answers to the one or more additional questions, solutions for solving problems in the one or more additional questions, and an educational content relating to the concept. The method further comprises: receiving, from the student, the student's answers to the one or more additional questions; identifying at least one of the one or more additional questions to which the student had an incorrect answer; and sending, to the student, one or more further additional questions relating to a concept included in the educational contents to which the at least one of the one or more additional questions relates.

One aspect of the invention provides an on-line education method coupled with an item pool and a lecture and performed through a system including a learner terminal accessible to an Internet, a main server connected to the learner terminal through the Internet, and a database connected to the main server to store predetermined education contents, in which the education contents stored in the database are provided to a learner under a control of the main server, the on-line education method comprising: (a) a basic learning step, in which the main server extracts a concept lecture video for a predetermined learning category from the database to provide the concept lecture video to the learner terminal; (b) a feedback learning step, in which the main server extracts several questions from the database and provides the questions to the learner terminal together with at least one of correct solutions, explanations, solution videos and concept videos to allow the learner to review a content of the concept video provided in step (a); (c) an instant test step, in which the main server provides the learner with questions together with at least one of a correct solution, explanation, a solution video and a concept video for each question by arranging the questions stored in the database according to a degree of difficulty and a number of questions selected by the learner; (d) an instant test feedback sham examination step, in which the main server extracts a predetermined number of questions, which are similar to the questions that the learner fails to answer in step (c), from the database and provides the questions to the learner; (e) an on-line sham examination step, in which the main server presents questions two to five times per a week, checks answers prepared by the learner and provides a test result to the learner together with at least one of a correct solution, explanation, a solution video and a concept video for each question; and (f) a clinic sham examination step, in which the main server presents a predetermined number of questions, which are similar to the questions that the learner fails to answer in the on-line sham examination step, checks answers prepared by the learner and provides a test result to the learner together with at least one of a correct solution, explanation, a solution video and a concept video for each question.

The on-line education method further comprises a final sham examination step, in which the main server extracts questions similar to the questions that the learner fails to answer in step (d) from the database to provide the learner with the extracted questions, wherein a number of questions provided in the final sham examination step are three to five times as many as a number of the questions that the learner fails to answer in step (d).

In step (b), questions similar to the questions selected by the learner are continuously and repeatedly provided to the learner. In step (c), the main server checks answers for the questions prepared by the learner and sends a result to a mobile phone of learner's parents. In step (d), questions similar to the questions that the learner fails to answer are provided to the learner, in which a number of the questions provided in step (d) are three to five times as many as a number of the questions that the learner fails to answer. In step (d), questions similar to the questions that the learner fails to answer are provided to the learner together with at least one of a correct solution, explanation, a solution video, and a concept video for each question. In step (d), the main server checks answers for the questions prepared by the learner and sends a result to a mobile phone of learner's parents.

The on-line education method further comprises a self-test step, in which the main server provides questions based on a subject, a unit, a degree of difficulty and a number of questions selected by the learner, checks answers for the questions prepared by the learner, and provides a test result to the learner together with at least one of a correct solution, explanation, a solution video, and a concept video for each question provided in the self-test step. Preferably, the questions are provided from the database according to selection of the learner, or subjective questions or blank-type questions are provided from the database according to selection of the learner.

The on-line education method further comprises a POD sham examination step, in which the main server randomly provides questions at a beginning of a month, checks answers for the questions prepared by the learner, and provides a test result to the learner together with at least one of a correct solution, explanation, a solution video, and a concept video for each question provided in the POD sham examination step. The on-line education method further comprises a clinic paper provision step, in which, after the questions provided in the POD sham examination step have been stored in the database, the main server provides the learner with questions, which are similar to the questions provided in the POD sham examination step, by extracting the questions from the database if the learner fails to answer the questions provided in the POD sham examination step, or the main server provides the learner with questions, which have a level higher than that of the questions provided in the POD sham examination step, by extracting the questions from the database if the learner gets correct answers for the questions provided in the POD sham examination step.

The on-line education method further comprises a retry step, in which the main server extracts questions selected by the learner from the database to provide the learner with the extracted questions after the questions provided in steps (c) to (f) have been stored in the database, wherein the questions provided in the retry step are similar to or the same as the questions that the learner fails to answer in the above steps. At least one of a correct solution, explanation, a solution video, and a concept video is provided for each question in the retry step.

### BRIEF DESCRIPTION OF DRAWINGS

FIG. 1 is a flowchart showing the procedure of an on-line education method coupled with an item pool and a lecture according to an embodiment of the present invention;

FIG. 2 is a schematic view showing an on-line education system coupled with an item pool and a lecture according to an embodiment of the present invention;

FIG. 3 is a view showing a screen image for performing the feedback learning according to an embodiment of the present invention;

FIG. 4 is a view showing a screen image for selecting the degree of difficulty and the number of items according to an embodiment of the present invention;

FIG. 5 is a view showing a screen image for performing an instant test according to an embodiment of the present invention;

FIG. 6 is a view showing a screen image for performing an on-line education method according to an embodiment of the present invention;

FIG. 7 is a view showing a screen image for performing an on-line sham examination according to an embodiment of the present invention;

FIGS. 8 and 9 are views for explaining the retry step that is performed when a learner fails to answer the question according to an embodiment of the present invention; and

FIGS. 10 and 11 are views showing screen images for performing the in-depth learning according to an embodiment of the present invention.

### DETAILED DESCRIPTION OF EMBODIMENTS

On-line education schemes are different from off-line education schemes in that the students do not need to move to the studying place and can select education contents suitable for the students from many lecture classes having various levels of difficulties. In the on-line educational system, however, the students cannot instantly ask questions while attending the on-line lecture when questions arise about the contents of the lecture. For this reason, the students may need to examine the whole education contents to answer the question, causing cumbersome to the students.

In addition, when the student fails to answer the question given from the item pool, the student may need to manually examine the on-line lecture to know the reason of failure and to find the part, which is not understood by the student, causing cumbersome to the students. In addition, since there is no teacher who inspects the learning attitude of the students, the iterative learning that is the most efficient method for improving the learning achievement is very difficult for the students who lack of tenacity. Even when the iterative learning is possible, it may be difficult to find the parts for the iterative learning because there are excessive amounts of education contents. Some embodiments of the present disclosure address the foregoing issues.

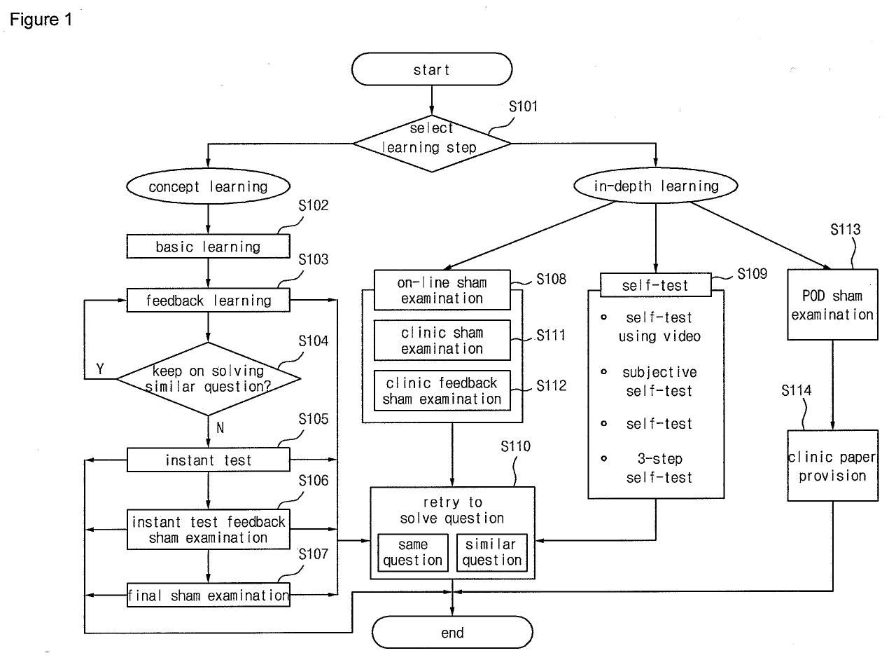

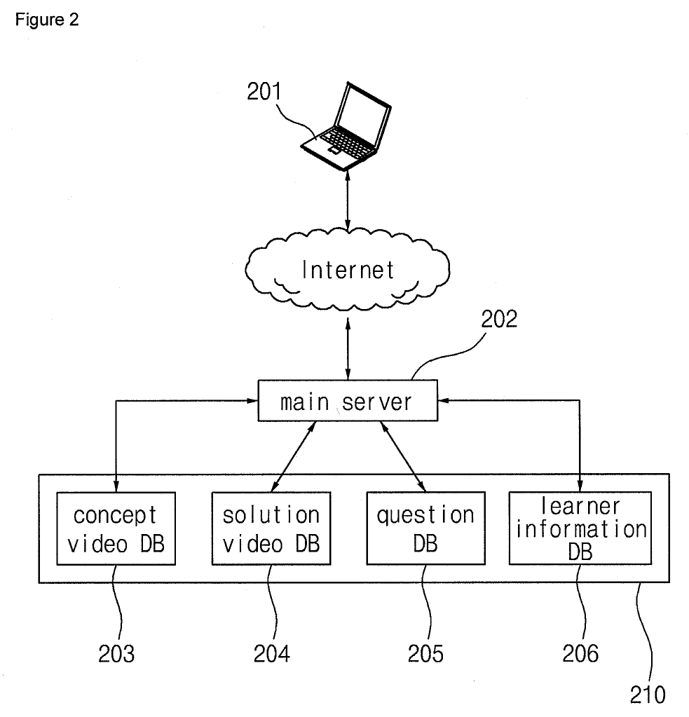

Hereinafter, an on-line education method coupled with an item pool and a lecture according to an exemplary embodiment of the present invention will be described with reference to the accompanying drawings. FIG. 1 is a flowchart showing the procedure of an on-line education method coupled with an item pool and a lecture according to an embodiment of the present invention, and FIG. 2 is a schematic view showing an on-line education system coupled with an item pool and a lecture according to an embodiment of the present invention.

Referring to FIG. 1, the on-line education method coupled with an item pool and a lecture according to an embodiment of the present invention comprises a basic learning step S102, a feedback learning step S103, an instant test step S105, an instant test feedback sham examination step S106, a final sham examination step S107, an on-line sham examination step S108, a self test step S109, a POD sham examination step S113, and a retry step S110.

In addition, referring to FIG. 2, the on-line education system coupled with an item pool and a lecture according to an embodiment of the present invention comprises a learner terminal 201, a main server 202 and a database 203. The main server 202 is connected to the learner terminal 201 through an Internet and has a function of providing various education contents to the learner by extracting and arranging the education contents stored in the database 210. The database 210 stores various education contents and includes a concept video DB 203, a solution video DB 204, a question DB 205 and a learner information DB 206 as shown in FIG. 2.

According to one embodiment of the on-line education method, the learner accesses the main server 202 through the learner terminal 201 (for example, an education PC, a PDA, a TV, a set-top box, etc) and selects the learning step (S101), so that the selected learning step is prosecuted.

In the basic learning step (S102), the main server 202 provides the learner with the concept lecture video for a predetermined learning category (for example, a subject, a lecturer, a unit, etc) selected by the learner by extracting and arranging the concept lecture video stored in the database 210.

The concept lecture video is a lecture video that explains the basic concept for the predetermined learning category or explains the basic concept for solving a predetermined question. The concept lecture video is stored in the concept video DB 203.

That is, in the basic learning step (S102), if the learner selects a predetermined learning category by using the learner terminal 201, the concept lecture video related to the predetermined learning category is provided to the learner so that the learner can study based on the concept lecture video.

At this time, the main server 202 provides the lecture video by enlarging the teaching text for explanation, thereby enhancing the degree of understand of the learner. In addition, it is possible to blank the important points of the teaching text in the lecture video.

In the feedback learning step (S103), the main server 202 provides the learner with several questions stored in the database 210 to allow the learner to review the learning category provided in the basic learning step (S102). At this time, each question is provided together with at least one of the correct solution, explanation, concept lecture video, and solution video. Preferably, all the correct solution, explanation, concept lecture video, and solution video are provided when each question is provided to the learner.

In the subject application, the provision of the question means that the main server 202 provides questions for examination by extracting and arranging questions stored in the question DB 205 and gives the learner with the grade for the examination. In addition, the solution video means the lecture video that solves the question in detail and explains the solution. The solution video is stored in the solution DB 204.

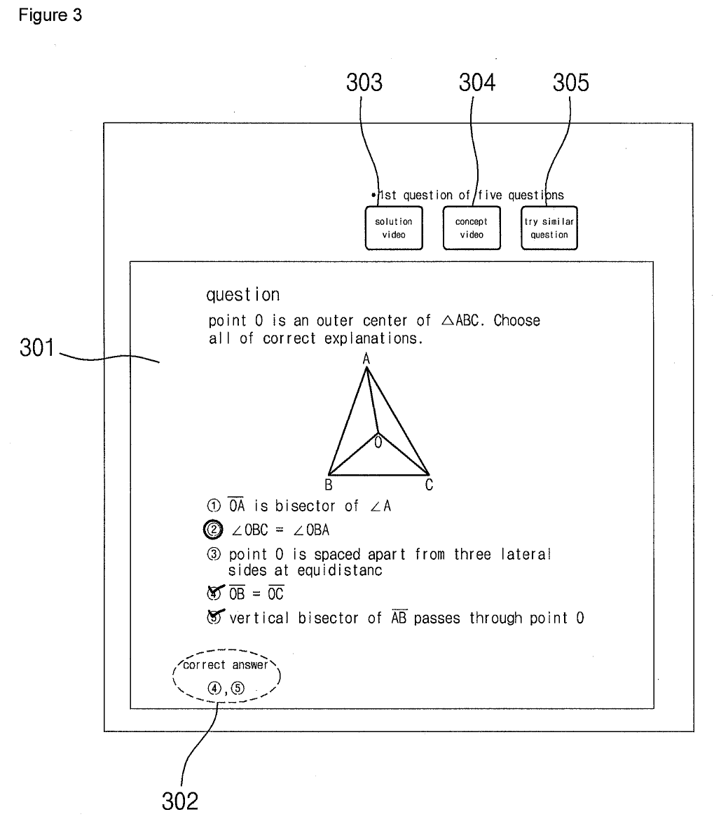

That is, in the feedback learning step (S103), the main server 202 provides the learner with the questions by extracting the questions related to the learning category of the basic learning step (S102). At this time, the main server 202 provides the correct solution, explanation, concept video and solution video together with the questions by extracting them from the concept video DB 203 and the solution video DB 204. For instance, a screen image as shown in FIG. 3 can be displayed on the learner terminal 201 when the feedback learning step S103 is prosecuted. That is, as shown in FIG. 3, a question 301 for evaluating educational achievement in the basic learning step S102, a correct solution 302 of the question 301, explanation (not shown), a solution video 303, and a concept video 304 are provided. At this time, five to ten questions can be presented. In addition, if the learner wants to deal with similar questions (S104), the feedback learning step (S103) is preferably repeated. For instance, if the learner clicks a button 305 for the similar question, the similar questions are repeatedly presented.

In the instant test step (S105), the questions related to the learning category of the basic learning step (S102) are provided to the learner. At this time, the learner can select the degree of difficulty and the number of questions. In addition, the correct solution, explanation, concept video and solution video are provided to the learner together with the questions.

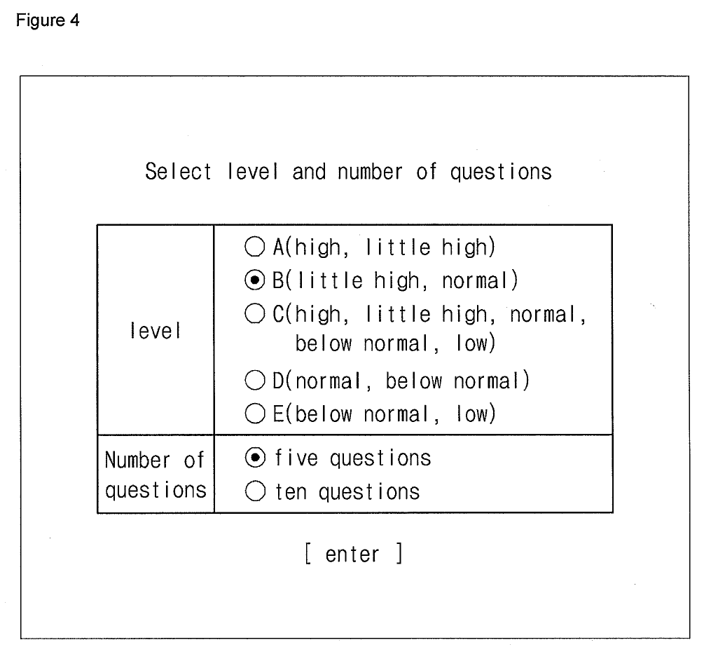

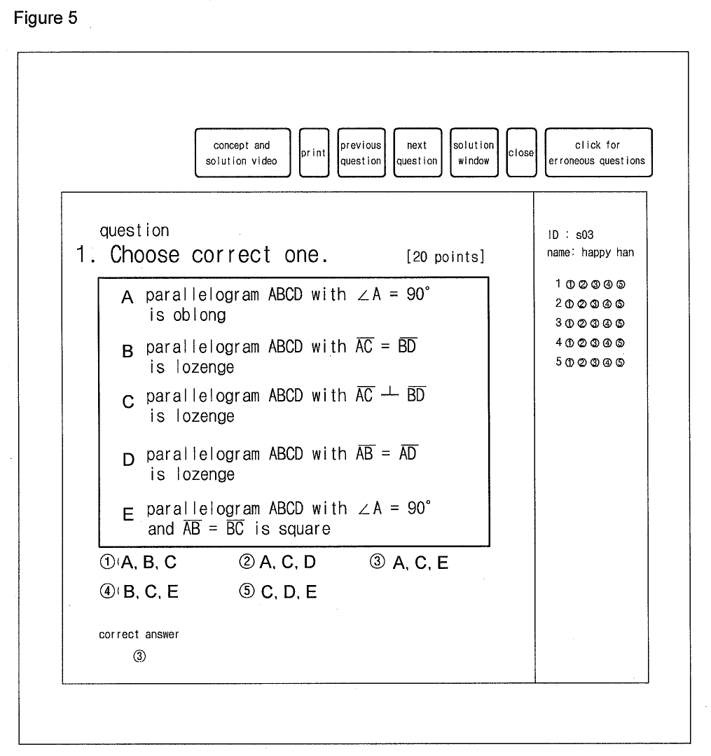

In detail, the learner selects the degree of difficulty and the number of questions related to the learning category of the basic learning step (S102) from the image screen as shown in FIG. 4. Referring to FIG. 4, the degree of difficulty is classified into five steps and the learner can select five to ten questions. However, the present invention is not limited thereto. When the learner has selected the degree of difficulty and the number of questions, the main server 202 extracts the questions from the question DB 205 and provides the questions to the learner according to the degree of difficulty and the number of questions selected by the learner. At this time, the main server 202 provides the correct solution, explanation, concept video and solution vides together with the questions by extracting them from the concept video DB 203 and the solution video DB 204. For instance, the image screen as shown in FIG. 5 is displayed on the learner terminal 201 for the instant test step (S105). That is, as shown in FIG. 5, the questions selected by the learner according to the degree of difficulty are provided together with the correct solution, explanation, the solution video, and the concept video for the questions.

The solution video, which is provided together with the questions in the feedback learning step (S103) and the instant test step (S105), is extracted from the solution video DB 204. Especially, in the case of objective-type questions provided with four different answers or five different answers, the solution video preferably explains the reason for incorrect answers in detail. In addition, the concept video, which is provided together with the questions in the feedback learning step (S103) and the instant text step (S105), is extracted from the concept video DB 203 and includes a basic concept for solving the questions.

In this manner, since the solution video and the concept video are provided together with the questions in the feedback learning step (S103) and the instant test step (S105), the learner may learn the contents related to the questions when solving the questions. In addition, if the learner can easily solve the question because the question has a relatively low degree of difficulty, the learner can skip the solution video and the concept video.

After the instant test step (S105), the main server 202 checks the solution of the question prepared by the learner and sends the test result to the mobile phone of learner's parents. Personal information of the learner is stored in the learner information DB 206 through a predetermined membership join procedure. At this time, the mobile phone number (in general, the mobile phone number of the learner's parents), to which the result of the instant test step (S105) is transmitted, is inputted and stored in the learner information DB 206.

In the instant test feedback sham examination step (S106), the main server 202 extracts questions, which are similar to the questions that the learner fails to answer in the instant test step (S105), from the question DB 205 and provides the extracted questions, which are three to five times as many as the questions that the learner fails to answer in the instant test step (S105), to the learner.

Similar to the instant test step (S105), the main server 202 checks the solution of the question prepared by the learner and sends the test result to the mobile phone of learner's parents in the instant test feedback sham examination step (S106).

In the final sham examination step (S107), questions which are similar to the questions that the learner fails to answer in the instant test feedback sham examination step (S106) are provided to the learner. In this step, the number of questions is three times as many as the questions that the learner fails to answer in the instant test feedback sham examination step (S106).

The correct solution, explanation, solution video and the concept video are provided together with the questions in the instant test feedback sham examination step (S106) and the final sham examination step (S107).

The above basic learning step (S102), the feedback learning step (S103), the instant test step (S105), the instant test feedback sham examination step (S106) and the final sham examination step (S107) may form one cycle relative to the predetermined learning category. However, the present invention is not limited thereto. For instance, the learner can stop the learning procedure in each step.

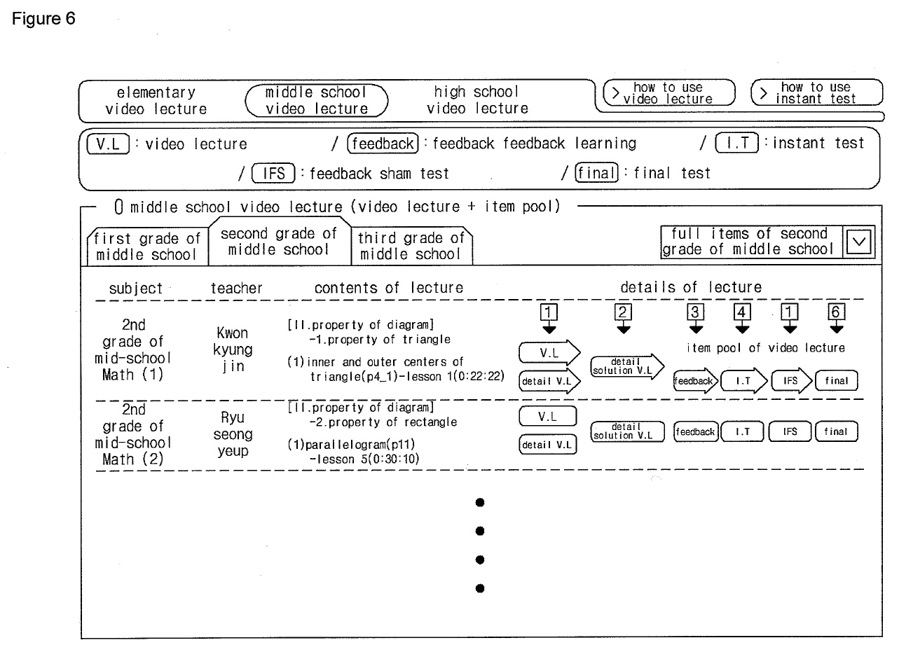

FIG. 6 is a view showing a screen image displayed on the learner terminal 201 for performing the on-line education method according to an embodiment of the present invention. As shown in FIG. 6, the learner can select the on-line lecture on the basis of the grades, subjects, and lectures of the lecturer. In addition, the learner can select the feedback learning, the instant test learning, the instant test feedback sham examination, or the final sham examination for the purpose of iterative learning.

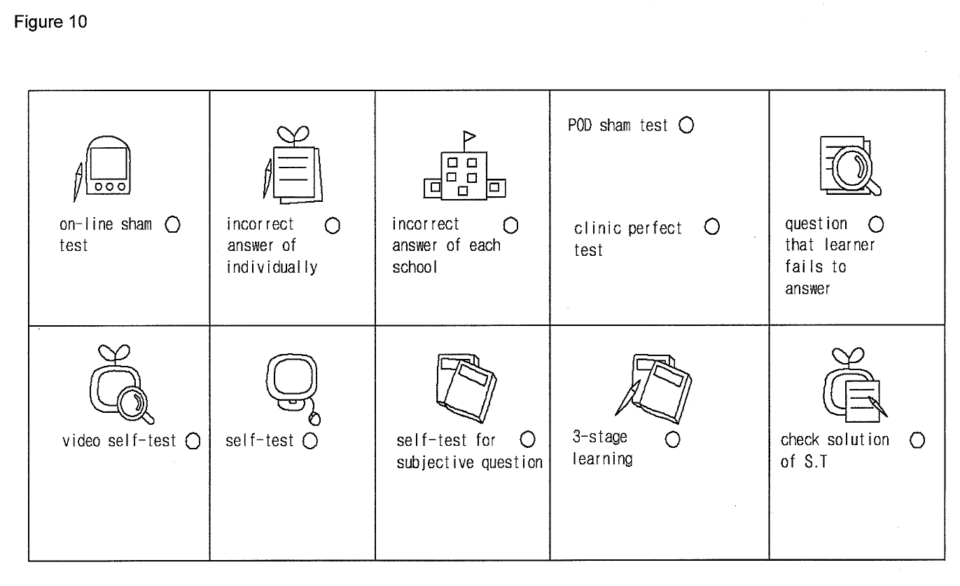

Meanwhile, in addition to the above learning steps, an in-depth learning step, such as an on-line sham examination step, a self-test step, and a POD sham examination step, is available for the learner through the image screen as shown in FIG. 10.

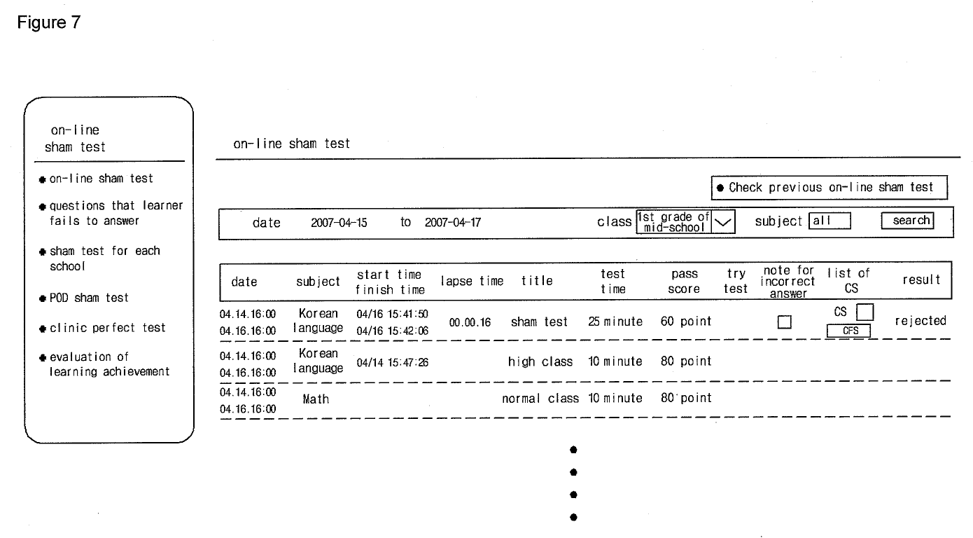

In the on-line sham examination step (S108), the main server 202 randomly extracts the questions from the question DB 205 and provides the questions to the learner terminal 201 by three times per a week to allow the learner to answer the questions. When the learner has solved the questions, the main server 202 checks the solution of the question prepared by the learner and provides the test result to the learner together with the correct solution, explanation, solution video and concept solution for the question. FIG. 7 is a view showing a screen image displayed on the learner terminal 201 for performing the on-line sham examination step (S108) according to an embodiment of the present invention.

In the on-line sham examination step (S108), the questions are randomly presented without taking personal capability into consideration and a message is transmitted to the mobile phone of the learner's parent after the questions have been provided to the learner.

In addition, after the on-line sham examination step (S108), a clinic sham examination step (S111) and a clinic feedback sham examination step (S112) are performed for the purpose of iterative learning. In the clinic sham examination step (S111), questions similar to the questions that the learner fails to answer in the on-line sham examination step (S108) are provided to the learner. The number of questions provided in the clinic sham examination step (S111) is the same as the number of questions that the learner fails to answer in the on-line sham examination step (S108). In the clinic feedback sham examination step (S112), questions similar to the questions that the learner fails to answer in the clinic sham examination step (S111) are provided to the learner. The number of questions provided in the clinic feedback sham examination step (S112) is three times as many as the number of questions that the learner fails to answer in the clinic sham examination step (S111).

In addition, the correct solution, explanation, solution video and concept video are provided for the questions that the learner fails to answer in the clinic sham examination step (S111) and the clinic feedback sham examination step (S112).

In the self-test step (S109), if the learner selects the subject, the unit, the degree of difficulty, and the number of questions, the questions selected by the learner are extracted from the question DB 205 and provided to the learner terminal 201. Then, if the learner submits the answers for the questions, the main server 202 checks the answers and provides the learner with the test result together with at least one of the corrected solution, explanation, solution video and concept video for the questions. At this time, data related to the educational achievement of the learner are stored in the learner information DB 206 and sent to the mobile phone of learner's parents.

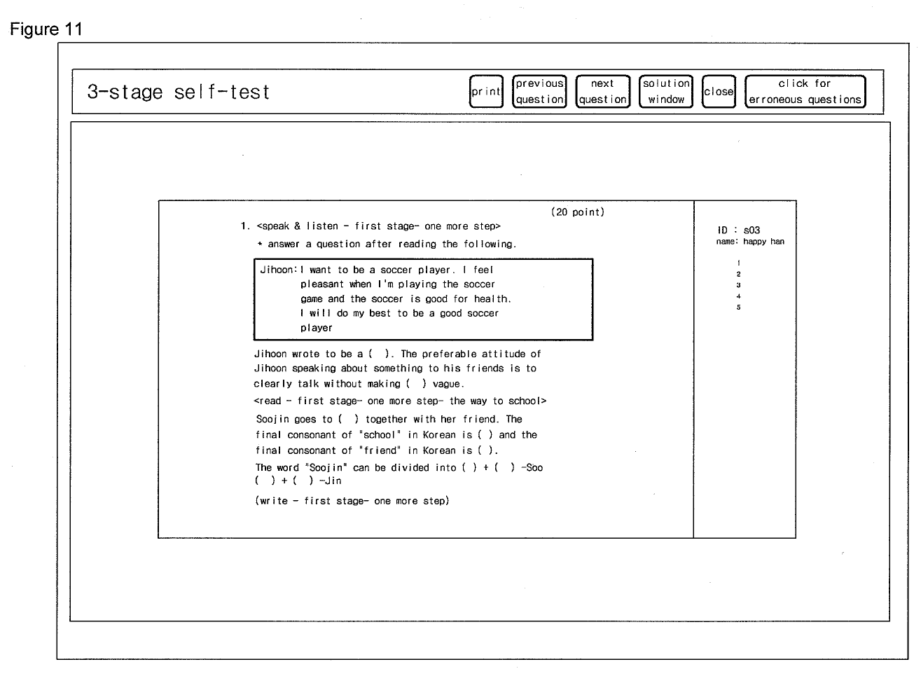

In the self-test step (S109), questions supported by the solution video are extracted from the question DB 205 to allow the learner to perform the self-test by using a video, or all the questions stored in the question DB 205 are provided in the self-test step (S109). In addition, subjective questions or blank-type questions can be exclusively extracted from the question DB 205 (subjective type self-test). In order to enable the learner to easily deal with the exposition-type questions, the blank-type questions can be provided in terms of section/chapter/unit (3-step self-test) in such a manner that the learner can confirm the correct solution only when the learner examines the textbooks and the reference books. FIG. 11 shows an image screen for performing the 3-step self-test.

In the POD sham examination step (S113), the main server 202 randomly extracts questions from the question DB 205 and provides the questions to the learner terminal at the beginning of the month to allow the learner to solve the questions. In addition, the main server 202 checks the answers and provides the learner with the test result together with at least one of the correct solution, explanation, solution video and concept video. The beginning of the month may be the first day or the fifth day of the month.

In addition, after the questions used in the POD sham examination step (S113) have been stored in the database, a clinic paper provision step (S114) is performed. If the learner fails to answer the questions provided in the POD sham examination step (S113), the main server 202 provides the learner with questions, which are similar to the questions provided in the POD sham examination step (S113), by extracting the questions from the database. In addition, if the learner gets correct answers for the questions provided in the POD sham examination step (S113), the main server 202 provides the learner with questions, which have a level higher than that of the questions provided in the POD sham examination step (S113), by extracting the questions from the database.

In the on-line education method according to one embodiment of the present invention, the questions (or the number of questions) that have been provided to the learner through the above procedure are stored in the learner information DB 206, so that the learner can download the questions by using the learner terminal 201. That is, the learner information DB 206 stores the questions provided to the learner under the control of the main server 202, so that the learner may recognize the questions that the learner fails to answer or gets correct answers. The retry step (S110) is for allowing the learner to solve again the questions that the learner fails to answer during the on-line education procedure according to one embodiment of the present invention.

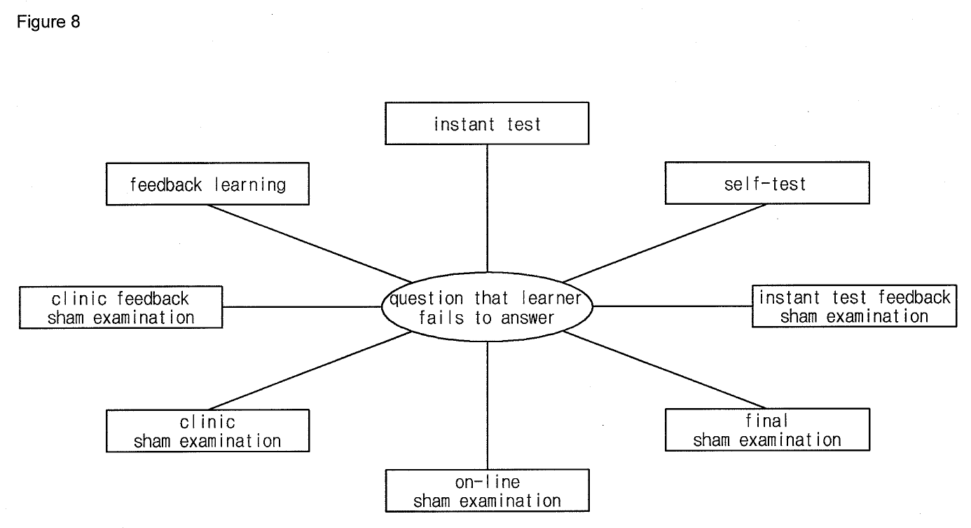

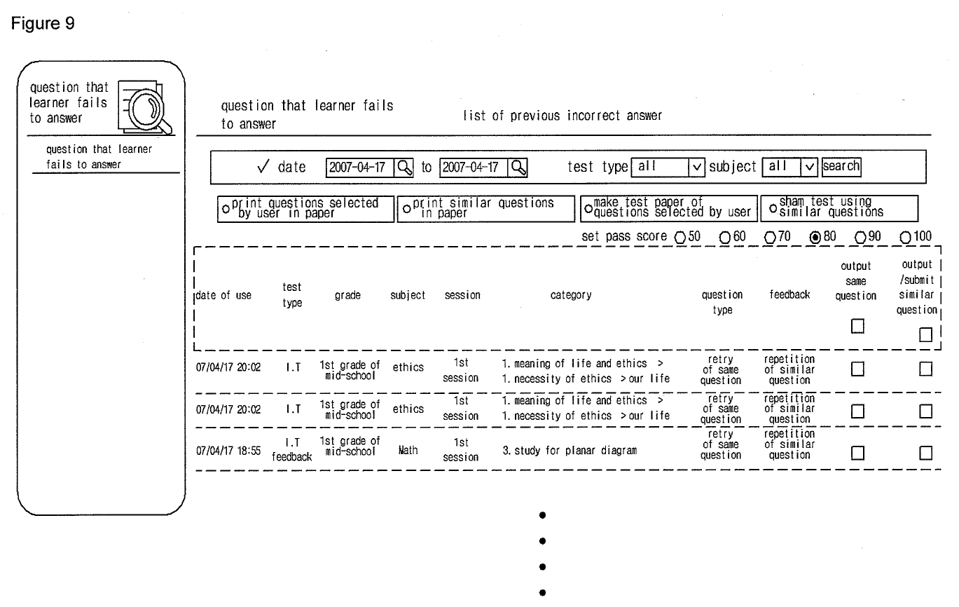

Referring to FIGS. 8 and 9, the questions provided to the learners in the feedback learning step (S103), the instant test step (S105), the instant test feedback sham examination step (S106), the final sham examination step (S107), the on-line sham examination step (S108), the clinic sham examination step (S111), the clinic feedback sham examination step (S112), and the self-test step (S109) are stored in the learner information DB 206. In the retry step (S110), the main server 202 extracts questions, which are similar to or the same as the questions that the learner fails to answer, to provide the questions to the learner terminal 201.

That is, the learner can search for the questions and select some questions that the learner fails to answer in the previous education steps. Thus, the learner can deal with the questions which are similar to or the same as the questions that the learner fails to answer. In addition, the learner can print out an examination paper consisting of the questions in off-line.

In addition, the correct solution, explanation, solution video and concept video are also provided to the learner in the retry step (S110).

Further, when loading the questions for the retry step (S110), questions having the degree of difficulty higher than that of questions that the learner gets correct answers are provided, or questions having the degree of difficulty identical to that of the questions that the learner fails to answer are provided.

Therefore, according to various embodiments of the present invention, the repeat learning is realized for a predetermined learning category, and the solution video and the concept video are provided together with the questions, so that the educational achievement of the learner can be improved.

Although the present disclosure discloses only certain embodiments of the invention, it is understood that the present invention should not be limited to these exemplary embodiments but various changes and modifications can be made by one ordinary skilled in the art within the spirit and scope of the present invention as hereinafter claimed.

What is claimed is:

1. An on-line education method coupled with an item pool and a lecture and performed through a system including a learner terminal accessible to an Internet, a main server connected to the learner terminal through the Internet, and a database connected to the main server to store predetermined education contents, in which the education contents stored in the database are provided to a learner under a control of the main server, the on-line education method comprising:
(a) a basic learning step, in which the main server extracts a concept lecture video for a predetermined learning category from the database to provide the concept lecture video to the learner terminal;
(b) a feedback learning step, in which the main server extracts several questions from the database and provides the questions to the learner terminal together with at least one of correct solutions, explanations, solution videos and concept videos to allow the learner to review a content of the concept video provided in step (a);
(c) an instant test step, in which the main server provides the learner with questions together with at least one of a correct solution, explanation, a solution video and a concept video for each question by arranging the questions stored in the database according to a degree of difficulty and a number of questions selected by the learner;
(d) an instant test feedback sham examination step, in which the main server extracts a predetermined number of questions, which are similar to the questions that the learner fails to answer in step (c), from the database and provides the questions to the learner;
(e) an on-line sham examination step, in which the main server presents questions two to five times per a week, checks answers prepared by the learner and provides a test result to the learner together with at least one of a correct solution, explanation, a solution video and a concept video for each question; and
(f) a clinic sham examination step, in which the main server presents a predetermined number of questions, which are similar to the questions that the learner fails to answer in the on-line sham examination step, checks answers prepared by the learner and provides a test result to the learner together with at least one of a correct solution, explanation, a solution video and a concept video for each question.

2. The on-line education method as claimed in claim 1, further comprising a final sham examination step, in which the main server extracts questions similar to the questions that the learner fails to answer in step (d) from the database to provide the learner with the extracted questions, wherein a number of questions provided in the final sham examination step are three to five times as many as a number of the questions that the learner fails to answer in step (d).

3. The on-line education method as claimed in claim 1, wherein, in step (b), questions similar to the questions selected by the learner are continuously and repeatedly provided to the learner.

4. The on-line education method as claimed in claim 1, wherein, in step (c), the main server checks answers for the questions prepared by the learner and sends a result to a mobile phone of learner's parents.

5. The on-line education method as claimed in claim 1, wherein, in step (d), questions similar to the questions that the learner fails to answer are provided to the learner, in which a number of the questions provided in step (d) are three to five times as many as a number of the questions that the learner fails to answer.

6. The on-line education method as claimed in claim 1, wherein, in step (d), questions similar to the questions that the learner fails to answer are provided to the learner together with at least one of a correct solution, explanation, a solution video, and a concept video for each question.

7. The on-line education method as claimed in claim 1, wherein, in step (d), the main server checks answers for the questions prepared by the learner and sends a result to a mobile phone of learner's parents.

8. The on-line education method as claimed in claim 1, further comprising a retry step, in which the main server extracts questions selected by the learner from the database to provide the learner with the extracted questions after the questions provided in steps (c) to (f) have been stored in the database, wherein the questions provided in the retry step are similar to or the same as the questions that the learner fails to answer in steps (c) to (f).

9. The on-line education method as claimed in claim 8, wherein at least one of a correct solution, explanation, a solution video, and a concept video is provided for each question in the retry step.

10. The on-line education method as claimed in claim 1, further comprising a self-test step, in which the main server provides questions based on a subject, a unit, a degree of difficulty and a number of questions selected by the learner, checks answers for the questions prepared by the learner, and provides a test result to the learner together with at least one of a correct solution, explanation, a solution video, and a concept video for each question provided in the self-test step.

11. The on-line education method as claimed in claim 10, wherein the questions are provided from the database according to selection of the learner.

12. The on-line education method as claimed in claim 10, wherein subjective questions or blank-type questions are provided from the database according to selection of the learner.

13. The on-line education method as claimed in claim 10, further comprising a retry step, in which the main server extracts questions selected by the learner from the database to provide the learner with the extracted questions after the questions provided in the self-test step has been stored in the database, wherein the questions provided in the retry step are similar to or the same as the questions that the learner fails to answer in the self-test step.

14. The on-line education method as claimed in claim 13, wherein at least one of a correct solution, explanation, a solution video, and a concept video is provided for each question in the retry step.

15. The on-line education method as claimed in claim 1, further comprising a POD sham examination step, in which the main server randomly provides questions at a beginning of a month, checks answers for the questions prepared by the learner, and provides a test result to the learner together with at least one of a correct solution, explanation, a solution video, and a concept video for each question provided in the POD sham examination step.

16. The on-line education method as claimed in claim 15, further comprising a clinic paper provision step, in which, after the questions provided in the POD sham examination step have been stored in the database, the main server provides the learner with questions, which are similar to the questions provided in the POD sham examination step, by extracting the questions from the database if the learner fails to answer the questions provided in the POD sham examination step, or the main server provides the learner with questions, which have a level higher than that of the questions provided in the POD sham examination step, by extracting the questions from the database if the learner gets correct answers for the questions provided in the POD sham examination step.

17. An on-line education method comprising:
sending educational contents to a remote terminal of a student;
providing the student with a plurality of degrees of difficulty of test questions for selection;
receiving, from the student, a selection of one of the plurality of degrees of difficulty;
sending, to the student, test questions on the educational contents, wherein the test questions are of the selected degree of difficulty; and
providing, to the student, at least one selected from the group consisting of correct answers to at least part of the test questions, solutions for solving problems in at least part of the test questions, and at least part of the educational contents relevant to solving at least part of the test questions.

18. The method of claim 17, further comprising:
prior to sending the test questions, selecting the test questions from a bank of questions in accordance with the selection.

19. The method of claim 17, further comprising:
providing the student with a choice of selecting a number of test questions; and
receiving, from the student, the selected number, wherein the selected number of test questions are sent to the student.

20. The method of claim 17, further comprising:
receiving, from the student, the student's answers to the test questions;
identifying at least one test question to which the student had an incorrect answer; and
sending, to the student, one or more additional questions relating to a concept included in the educational contents to which the at least one test question relates.

21. The method of claim 20, further comprising:
providing, to the student, at least one selected from the group consisting of correct answers to the one or more additional questions, solutions for solving problems in the one or more additional questions, and an educational content relating to the concept.

22. The method of claim 20, further comprising:
receiving, from the student, the student's answers to the one or more additional questions;
identifying at least one of the one or more additional questions to which the student had an incorrect answer; and
sending, to the student, one or more further additional questions relating to a concept included in the educational contents to which the at least one of the one or more additional questions relates.
